(19) United States
(12) Patent Application Publication
(10) Pub. No.: US 2018/0052221 A1
(43) Pub. Date: Feb. 22, 2018

(54) RF ID Verifier

(71) Applicant: SPAWAR Systems Center Pacific, San Diego, CA (US)

(72) Inventors: Ricardo Santoyo-Mejia, Chula Vista, CA (US); Nazia Ahmed Mozaffar, San Diego, CA (US); Christopher Richard Milligan, Alexandria, VA (US); David Carlos Dawson, Lemon Grove, CA (US)

(73) Assignee: United States of America as represented by Secreta ry of the Navy, San Diego, CA (US)

(21) Appl. No.: 15/240,786

(22) Filed: Aug. 18, 2016

(51) Int. Cl. G01S 7/40; H01Q 15/14; G01S 7/38

(52) U.S. Cl. CPC G01S 7/4004; G01S 7/38; H01Q 15/14

(57) ABSTRACT

A device is provided for use with a modulator and radar reflector, the modulator being operable to generate a modulation signal, the radar reflector being operable to generate a reflected radar signal based on the modulation signal and a radar signal. The device includes: a radar transmitter operable to transmit the radar signal; a radar receiver operable to receive the reflected radar signal; an oscilloscope operable to generate a received signal based on the reflected radar signal; and an output component operable to output an output signal based on the received signal.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 102,681.

### BACKGROUND OF THE INVENTION

Radar has long been utilized to detect object parameters (e.g. distance, speed, direction, etc.), in addition to analyzing weather and geological systems. Using electromagnetic radio waves, these systems are used for line-of-sight transmission and detection. Traditional systems utilize an antenna to emit the radio wave, which is reflected off of objects and returned to the transmitter. Changes in radio wave parameters, such as phase, frequency and amplitude can be used to determine characteristics of the reflecting object.

Radio waves can also be used to transmit and receive data, such as in frequency-modulated systems like FM radio, whereby a station transmits data that is received by a secondary receiver, such as a car antenna. In contrast to the previously described system, which utilizes a separate transmitter and receiver, it is also possible to embed information into otherwise passively reflected radio waves. For example, a single transceiver may transmit a radio wave that is reflected from a plane and back to the original transceiver. In traditional systems, the reflected radio wave could be used to determine distance, speed and direction. Modern systems can also be equipped to embed data into the reflected signal. Using the example of the plane, a system on the plane could actively modulate and alter the reflected signal, whereby the transceiver would receive a modified radio wave. Similar to Morse code, the embedded signal could be demodulated at the transceiver, thereby allowing the plane to communicate with the transmission station.

The present invention is intended to verify functionality of the reflector and modulator systems.

### SUMMARY OF THE INVENTION

An aspect of the present invention is drawn to a device for use with a modulator and radar reflector, the modulator being operable to generate a modulation signal, the radar reflector being operable to generate a reflected radar signal based on the modulation signal and a radar signal. The device includes: a radar transmitter operable to transmit the radar signal; a radar receiver operable to receive the reflected radar signal; an oscilloscope operable to generate a received signal based on the reflected radar signal; and an output component operable to output an output signal based on the received signal.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIG. 1 illustrates an example prior art radar system:

FIG. 2 illustrates an example radar system enabled for communication;

FIG. 3 illustrates an example system to detect, modify and verify a radar signal;

FIG. 4 illustrates an example verifier system; and

FIG. 5 illustrates an example system to externally validate signal modification.

### DETAILED DESCRIPTION OF THE EMBODIMENTS

Embodiments of the invention verify, in a portable manner, the functionality of energy reflecting devices.

A device is designed to verify the functioning of radar reflectors. It includes a radar and a demodulator. Specifically, the radar is a tunable continuous wave (CW) homodyne radar that can verify the operation of reflectors in selected frequencies of the X and Ku band. The radar receives signal through an antenna. It demodulates the received signal and displays it on its built-in oscilloscope.

A single local oscillator generates a sinusoid at a selected frequency. The local oscillator has a multiplier to generate and amplify a plurality of selectable frequencies in the Ku band. Low-band frequencies are amplified by a low-noise amplifier. The selected signal is transmitted through the antenna to the reflector. The reflector is an active device that can reflect a modulated radar signal based on a modulation scheme provided by a modulator at the reflector. The reflected, modulated signal is received through the same antenna that transmitted the original signal. The received modulated reflected signal is fed to the detector circuit for amplitude adjustment and demodulation. Demodulated signal is then displayed on the oscilloscope.

Before a system of the present invention is discussed, prior art radar systems will be discussed to provide background.

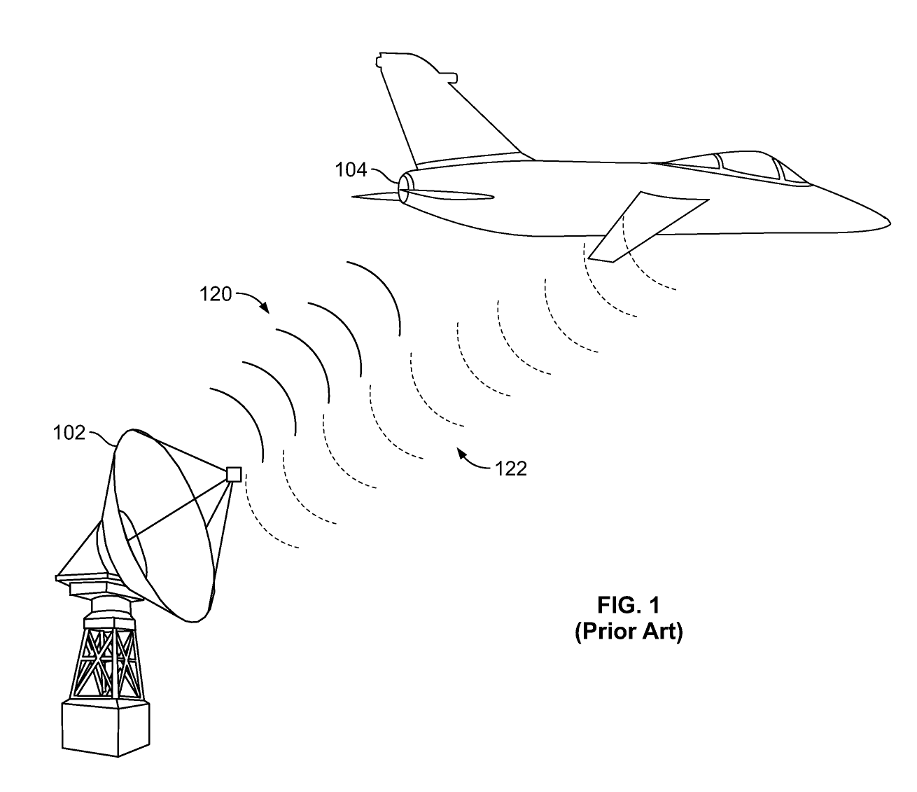

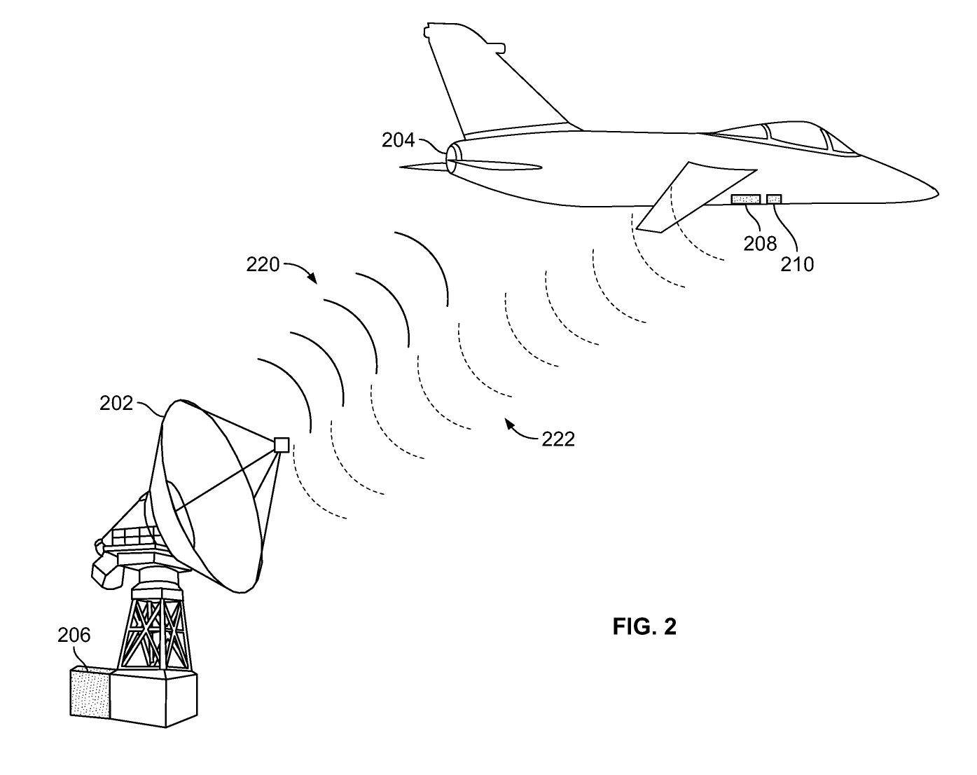

Prior art and conventional radar systems will now be described with reference to FIGS. 1-2.

FIG. 1 illustrates an example prior art radar system.

As shown in the figure, the radar system includes a ground transceiver 102 and a plane 104.

Ground transceiver 102 is arranged to communicate with plane 104 by way of a radar communication channel 120. Plane 104 is arranged to communicate with ground transceiver 102 by way of a radar communication channel 122.

Ground transceiver 102 may be any device or system that is operable to generate and receive radar signals. Non-limiting examples of transmission systems include parabolic and phased array transmitters, and associated receivers operating at a frequency between 3 MHz and 100 GHz.

In operation, ground transceiver 102 may transmit radar signals and receive reflected signals used, for example, to detect the presence of unknown objects or track objects. Communication channel 120 represents the transmitted signal and communication channel 122 represents a passively reflected signal that is then received by ground transceiver 102.

It has been previously demonstrated that reflected radar signal could additionally be utilized for communication by modulating the otherwise passive reflection. With modulation, data could be embedded into the reflected signal. This will be described with additional reference to FIG. 2.

FIG. 2 illustrates an example radar system enabled for communication.

As shown in the figure, the system includes a ground transceiver 202 and a plane 204. Ground transceiver 202 additionally includes a demodulator 206. Plane 204 additionally includes a reflector 208 and a modulator 210.

Ground transceiver 202 is arranged adjacent to and in communication with demodulator 206. Reflector 208 and modulator 210 are arranged on plane 204. Reflector 208 is arranged adjacent to and in communication with modulator 210. Ground transceiver 202 is arranged to communicate with plane 204 by way of a radar communication channel 220. Plane 204 is arranged to communicate with ground transceiver 202 by way of a radar communication channel 222.

Ground transceiver 202 may be any device or system that is operable to generate and receive radar signals. Non-limiting examples of transmission systems include parabolic and phased array transmitters and associated receivers operating at a frequency between 3 MHz and 100 GHz.

Demodulator 206 may be any device or system that is operable to detect modifications to the signal generated by ground transceiver 202.

Reflector 208 may be any device or system that is operable to reflect a radar signal.

Modulator 210 may be any device or system that is operable to modify a radar signal in combination with reflector 208. Non-limiting examples of signal modification may include changes to the frequency, wavelength, amplitude, pulse repetition or pulse length.

In operation, ground transceiver 202 may transmit radar signals and receive reflected signals used, for example, to detect the presence of unknown objects, track objects, or transmit data to an ancillary system. Communication channel 220 represents the transmitted signal and communication channel 222 represents both the passively and actively reflected signal that is then received by ground transceiver 202. Stimulated by modulator 210, reflector 208 may modify the radar signal in order to embed data in the transmission. Ground transceiver 202 may then detect the reflected signal, which is then processed by demodulator 206 to detect any information embedded in the signal.

Given the common use of radar systems, embedding data into a reflected signal provides an additional communication channel with little cost. These systems could increase the available modes of communication and utilize different infrastructure. Increased redundancy of communication systems may reduce the opportunity for communication failures.

Despite the current use of communication systems utilizing reflected radar, there is no easy method to verify reflector functionality. With reference to FIG. 2, reflector 208 or modulator 210 may degrade with time and use, and this degradation could negatively affect functionality, decreasing the signal-to-noise ratio or otherwise compromising effective data transmission. Current systems to validate reflectors are not portable and require bench-top measurements. This prevents testing reflectors in the field. A portable system to verify reflector operation is needed.

Aspects of the present invention provide a system and method to portably verify a reflector.

The verifier is a portable device enabled to transmit and receive radio signals, demodulate signals, and output signals to an external device. In operation, the verifier would transmit a radio signal using an antenna, which would be modulated and reflected by a reflector being tested. Upon receiving the reflected radio signal, the verifier demodulates the signal. For portable screening, an internal oscilloscope could be used to display the demodulated signal for comparison against expectation. Further verification can be conducted by using an external oscilloscope. The verifier can output the demodulated signal, and the modulator of the reflecting device can output the modulation signal; an external oscilloscope can be used to display and compare both signals concurrently.

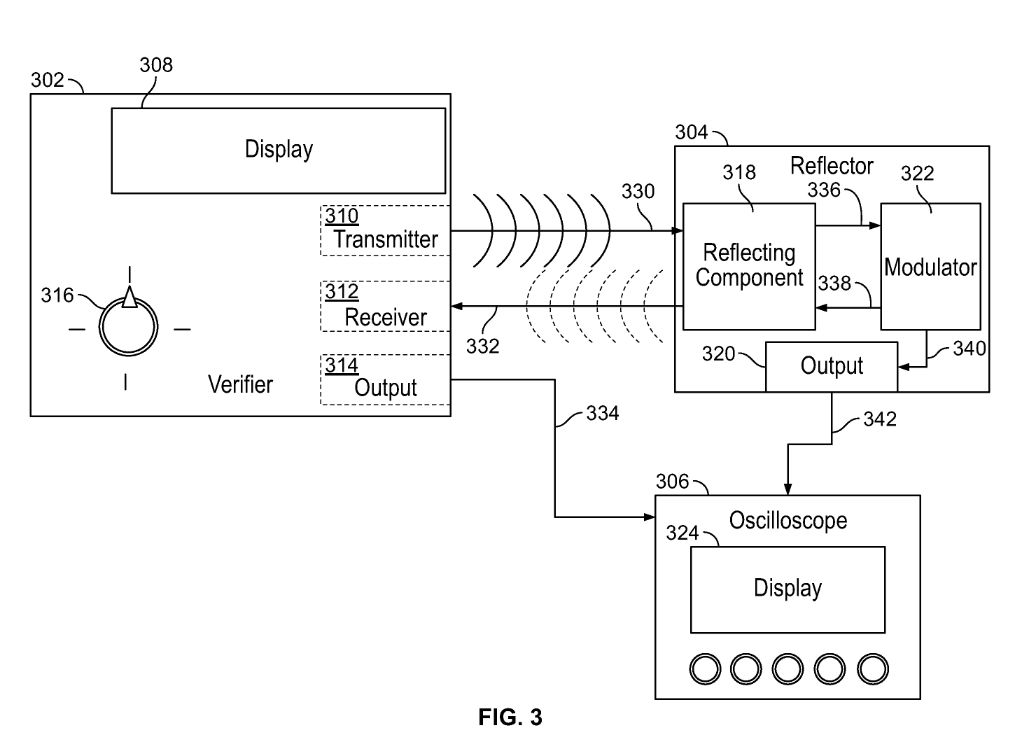

Aspects of the present invention will be further described with reference to FIGS. 3-5.

FIG. 3 illustrates an example system to detect, modify and verify a radar signal.

As shown in the figure, the system includes a verifier 302, a reflector 304 and an oscilloscope 306. Verifier 302 additionally includes a verifier display 308, a verifier transmitter 310, a verifier receiver 312, a verifier output 314 and a frequency selector 316. Reflector 304 additionally includes a reflecting component 318, a reflector output 320 and a modulator 322. Oscilloscope 306 additionally includes an oscilloscope display 324.

Verifier display 308 and frequency selector 316 are arranged in view on the enclosure of verifier 302, whereas verifier transmitter 310, verifier receiver 312 and verifier output 314 may be arranged within the enclosure of verifier 302. Verifier 302 is arranged to communicate with reflector 304 by way of a radar communication channel 330 and a radar communication channel 332. In particular, verifier transmitter 310 is arranged to communicate to reflecting component 318 by communication channel 330, whereas reflecting component 318 is arranged to communicate to verifier receiver 312 by communication channel 332. Reflecting component 318, reflector modulator 322 and reflector output 320 are arranged within the enclosure of reflector 304. Reflecting component 318 is arranged to communicate with modulator 322 by way of communication channel 336. Modulator 322 is further arranged to communicate with reflecting component 318 by way of communication channel 338 and with reflector output 320 by way of communication channel 340. Additionally, verifier output 314 is arranged to communicate with oscilloscope 306 by way of communication channel 334, whereas reflector output 320 is arranged to communicate with oscilloscope 306 by way of communication channel 342.

Verifier transmitter 310 may be any device or system operable to generate and transmit a radar signal. Verifier receiver 312 may be any device or system operable to receive a radar signal. Non-limiting examples include parabolic and phased array transmitters and associated receivers operating at a frequency between 3 MHz and 100 GHz. Frequency selector 316 is utilized to select the transmission band used in operation.

Although verifier 302 is identified to include verifier transmitter 310 and verifier receiver 312 separately, in some embodiments verifier transmitter 310 and verifier receiver 312 may be a single transceiver.

Verifier output 314 may be any device or system to that enables verifier 302 to output a signal to an ancillary device. Non-limiting examples of verifier output 314 include wired systems such as fiber optic and copper cabling or wireless transmission systems such as Wi-Fi and Bluetooth.

Verifier display 308 may be any device or system to provide visual representation of the data.

Reflecting component 318 may be any device or system operable to receive and modulate a radar signal based on stimulating voltage provided by modulator 322.

Modulator 322 may be any device or system that is operable to modify the characteristics of a radar signal to relay data. Non-limiting examples of signal modification may include changes to the frequency, wavelength, amplitude, pulse repetition or pulse length.

Reflector output 320 may be any device or system that enables reflector 304 to output a signal to a separate device. Non-limiting examples of reflector output 320 include wired systems such as fiber optic and copper cabling or wireless transmission systems such as Wi-Fi and Bluetooth.

Oscilloscope 306 is enabled to receive signals and graphically display them on oscilloscope display 324.

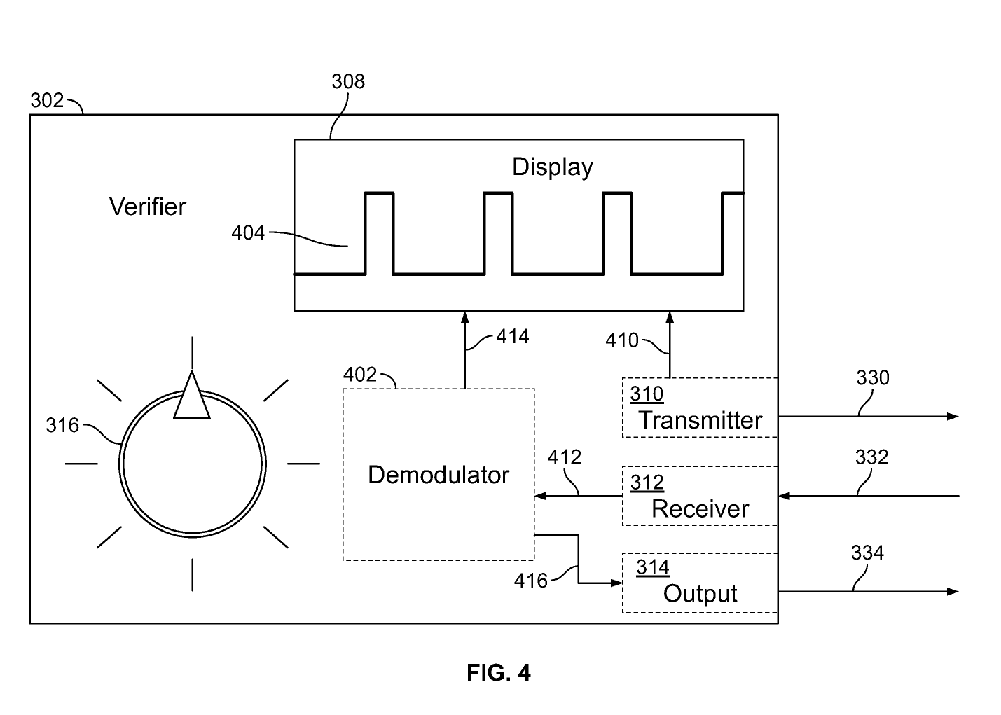

A more detailed discussion of verifier 302 will now be described with additional reference to FIG. 4.

FIG. 4 illustrates an exploded view of verifier 302.

As shown in the figure, verifier 302 includes verifier display 308, verifier transmitter 310, verifier receiver 312, verifier output 314 and frequency selector 316. Verifier 302 additionally includes a demodulator 402. Verifier display 308 additionally includes a demodulated signal 404.

Verifier display 308 and frequency selector 316 are arranged in view on the enclosure, whereas demodulator 402 may be arranged within the enclosure of verifier 302. Verifier receiver 312 is arranged in communication with demodulator 402 by way of communication channel 412. Demodulator 402 is arranged in communication with verifier output 314 and verifier display 308 by way of communication channels 414 and 416. In particular, demodulator 402 is arranged to communicate to verifier display 308 by way of communication channel 414 and demodulator 402 is arranged to communicate with verifier output 314 by way of communication channel 416. Verifier transmitter 310 is arranged in communication with verifier display 308 by way of communication channel 410.

Frequency selector 316 may be any device or system used to allow an operator to adjust transmission frequencies of verifier 302 as required for testing.

Demodulator 402 may be any device or system that is operable to detect modifications to the signal generated by verifier transmitter 310 and reflected by reflector 304.

In operation, verifier transmitter 310 generates a radar signal based on frequency determined by frequency selector 316.

Returning to FIG. 3, and in operation as a non-communicating system, reflector 304 would reflect radar energy passively and without modulation. Upon engaging modulator 322, reflector 304 would produce a modulated radar signal with embedded information. Modulator 322 provides the driving voltage to reflector 304, enabling signal modulation and the embedding of data within radar communication channel 332. Non-limiting examples of signal modification include changes to frequency, wavelength, amplitude, pulse repetition, or pulse length.

Returning to FIG. 4, verifier receiver 312 would then receive the modulated and reflected radar signal. Demodulator 402 would then determine the presence of any signal modifications. Verifier display 308 may be used to display the demodulated signal 404. While not shown, verifier display 308 may also be enabled to show the transmitted and as-received signals without demodulation for additional validation. Using frequency selector 316, an operator may adjust transmission signal characteristics in accordance to testing requirements. Additionally, the original verifier transmission signal, reflected signal, and demodulated signal may be output to an external device by way of verifier output 314.

Returning to FIG. 3, reflector 304 may output the signal from modulator 322 using reflector output 320.

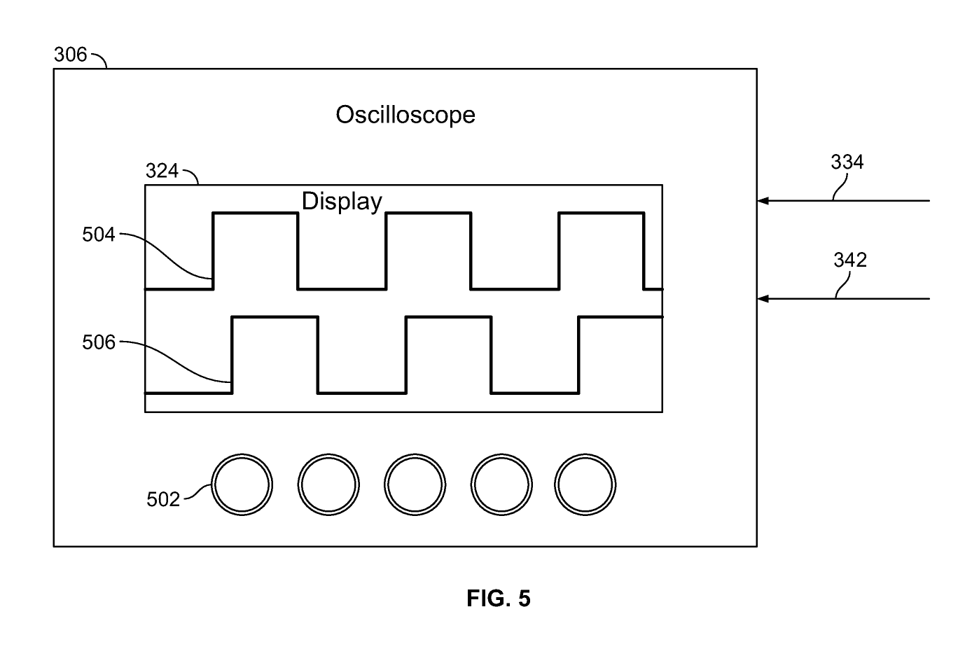

In this way, verifier 302 may be used independently or in conjunction with an external device such as oscilloscope 306 to validate operation. Oscilloscope 306 may be used to verify the functionality of verifier 302 by comparing the demodulated signal with that from reflector 304. A more detailed discussion of oscilloscope 306 will now be described with additional reference to FIG. 5.

FIG. 5 illustrates an example system to externally validate signal modification.

As shown in the figure, the system includes oscilloscope 306 and oscilloscope display 324. Oscilloscope 306 additionally includes a dial bank 502. Oscilloscope display 324 additionally includes a modulator signal 504 and a verifier signal 506.

Oscilloscope display 324 and dial bank 502 are arranged in view on the enclosure of oscilloscope 306. Modulator signal 504 and verifier signal 506 are arranged within oscilloscope display 324.

Dial bank 502 includes a plurality of dials enabled to control oscilloscope display 324.

In operation, oscilloscope display 324 may be used to monitor signals of both verifier 302 and reflector 304. For example, oscilloscope display may be configured to display modulator signal 504 from reflector 304 in conjunction with demodulated verifier signal 506 from verifier 302. In a given configuration, oscilloscope display 324 may graphically display these signals, whereby modulator signal 504 from modulator 322 has similar frequency, amplitude and pulse frequency comparable to the demodulated verifier signal 506 from verifier 302. In this example, the system is operating correctly. Alternatively, if reflector 304 or components therein were not operating correctly, these two signals would not be comparable, and would demonstrate device failure.

In summary, the described invention provides a basis to improve reflector testing. Previous systems used laboratory-based equipment, requiring bench top measurements and were not portable. This limitation reduced or prevented the opportunity to verify reflector functionality in the field. The current disclosure describes a system equipped to validate reflector function using a portable device with a built-in oscilloscope and versatile frequency band options. The system additionally allows testing with an auxiliary oscilloscope, enabling a user to validate the radar testing equipment.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a modulator and radar reflector, the modulator being operable to generate a modulation signal, the radar reflector being operable to generate a reflected radar signal based on the modulation signal and a radar signal, said device comprising:
a radar transmitter operable to transmit the radar signal:
a radar receiver operable to receive the reflected radar signal;
an oscilloscope operable to generate a received signal based on the reflected radar signal; and
an output component operable to output an output signal based on the received signal.

2. The device of claim 1, wherein said radar transmitter comprises a frequency selector operable to select one of a plurality of frequencies to transmit as the radar signal.

3. The device of claim 2, wherein said output component comprises a graphical display.

4. The device of claim 3, wherein said radar receiver comprises a demodulator operable to demodulate the reflected radar signal.

5. The device of claim 4, wherein said output component further comprises an output port operable to output the output signal.

6. The device of claim 1, wherein said output component comprises a graphical display.

7. The device of claim 6, wherein said radar receiver comprises a demodulator operable to demodulate the reflected radar signal.

8. The device of claim 7, wherein said output component further comprises an output port operable to output the output signal.

9. A system comprising:
a modulator operable to generate a modulation signal;
a radar reflector being operable to generate a reflected radar signal based on the modulation signal and a radar signal;
a radar transmitter operable to transmit the radar signal:
a radar receiver operable to receive the reflected radar signal;
an oscilloscope operable to generate a received signal based on the reflected radar signal; and
an output component operable to output an output signal based on the received signal.

10. The device of claim 9, wherein said radar transmitter comprises a frequency selector operable to select one of a plurality of frequencies to transmit as the radar signal.

11. The device of claim 10, wherein said output component comprises a graphical display.

12. The device of claim 11, wherein said radar receiver comprises a demodulator operable to demodulate the reflected radar signal.

13. The device of claim 12, wherein said output component further comprises an output port operable to output the output signal.

14. The device of claim 9, wherein said output component comprises a graphical display.

15. The device of claim 14, wherein said radar receiver comprises a demodulator operable to demodulate the reflected radar signal.

16. A method comprising:
generating, via a modulator, a modulation signal;
transmitting, via a radar transmitter, a radar signal;
generating, via a radar reflector, a reflected radar signal based on the modulation signal and the radar signal;
receiving, via a radar receiver, the reflected radar signal;
generating, via an oscilloscope, a received signal based on the reflected radar signal; and
outputting, via an output component, an output signal based on the received signal.

17. The method of claim 16, wherein said transmitting, via a radar transmitter, a radar signal comprises selecting, via a frequency selector, one of a plurality of frequencies to transmit as the radar signal.

18. The method of claim 17, wherein said outputting, via an output component, an output signal based on the received signal comprises outputting via a graphical display.

19. The method of claim 18, wherein said receiving, via a radar receiver, the reflected radar signal comprises demodulating, via a demodulator, the reflected radar signal.

20. The method of claim 19, wherein said outputting, via an output component, an output signal based on the received signal further comprises outputting, via an output port, the output signal.
